(19) United States
(12) Patent Application Publication
(10) Pub. No.: US 2024/0324508 A1
(43) Pub. Date: Oct. 3, 2024

(54) HARVESTING HEADER FOR A COMBINE HARVESTER FOR HARVESTING CROPS WITH GRAINS GROWING ON STALKS

(71) Applicant: Deere & Company, Moline, IL (US)

(72) Inventor: Emmanuel R. Magisson, Zweibrücken (DE)

(21) Appl. No.: 18/417,355

(22) Filed: Jan. 19, 2024

(30) Foreign Application Priority Data
Mar. 27, 2023 (DE) 102023107613.2

(51) Int. Cl. A01D 41/14

(52) U.S. Cl. CPC A01D 41/141

(57) ABSTRACT

A harvesting header for a combine harvester for harvesting crops with grains growing on stalks. The harvesting header includes a frame structure movable in a forward direction over a field to which a harvesting device is attached, which extends over the entire width of the harvesting header to harvest the grains of the crop, the crop flow of which can be fed through a rear dispensing opening of the harvesting header to a feeder house of the combine harvester. The harvesting header includes a central portion, which is situated in front of the feeder house, and a left-hand portion and a right-hand portion which are each laterally offset in relation to the central portion. The harvesting header is configured to feed stalks that enter the central portion to the feeder house along with the grains.

### RELATED APPLICATION

This application claims priority to application DE 10 2023 107 613.2, filed Mar. 27, 2023, which is incorporated herein by reference in its entirety.

### FIELD OF THE DISCLOSURE

The present disclosure relates generally to a combine harvester and more particularly to a crop residue distributor assembly for a combine harvester.

### BACKGROUND

It has been proposed numerous times in the past to operate the cutting unit of a combine harvester, when harvesting relatively long-stalked grains, in a so-called high-cutting mode in which the cutter bar of the cutting unit is guided at a relatively great height above the ground at a short distance below the cars, or to cut the cars from the stalks using a so-called stripper. This avoids the need to process straw through the combine harvester, which consumes a relatively great amount of energy. Those stalks which are not cut off by the cutter bars or which remain standing on the field after the stripping operation are cut off and/or comminuted means of suitable devices, so-called secondary or additional cutting units, and deposited on the field in a windrow (DD 117 584 A, DD 243 201 A, FR 2 794 608 A, DE 10 2005 025 319 A1, DE 10 2014 014 871 B3, U.S. Pat. No. 9,788,486 B2) or so as to be distributed across the entire cutting width of the combine harvester (DD 117 584 A, DD 10 896 A, DD 135 029 A, DD 243 201 A, DE 24 18 995 A1, DE 43 24 812 A, DE 43 24 813 C, DE 85 24 124 U, EP 1 378 159 A, EP 1 483 953 A, FR 1 371 068 A, DE 10 2005 025 319 A1, DE 10 2013 107 148 A1, DE 10 2014 014 871 B3, U.S. Pat. No. 9,788,486 B2).

In the references, the additional cutting units extend over the entire width of the harvesting header, that is to say also under the center of the harvesting header, to the rear side of which the feeder house is coupled. This has the disadvantage that the additional cutting unit must be dimensioned to have a height small enough that it can be located underneath the feeder house. Furthermore, in the case of lodged cereal crops, the harvesting header cannot be lowered further than is allowed by the additional cutting unit, and ultimately only very little non-grain material (in particular straw) passes through the combine harvester. This non-grain material however has the effect of lowering the aggressiveness of the threshing and separating devices and thus reducing damage to the grain during the threshing and separating operations.

### SUMMARY

The problem addressed by the present disclosure is considered that of equipping a harvesting header for harvesting cereal crops, which is improved in relation to the references and which harvests only the upper parts of the plants, with an additional cutting unit for the stalks, which additional cutting unit does not exhibit the stated disadvantages, or exhibits the stated disadvantages to a lesser extent.

This problem is solved according to the present disclosure by the teaching of claim 1, wherein the further claims list features that advantageously develop the solution.

A harvesting header for a combine harvester for harvesting crops with grains growing on stalks comprises a frame structure which is movable in a forward direction over a field and to which there are attached a harvesting device, which extends over the entire width of the harvesting header and which serves for harvesting the grains of the crop, the crop flow of which can be fed through a rear dispensing opening of the harvesting header to a feeder house of the combine harvester, and an additional cutting unit for processing the stalks that remain on the field after the grains have been harvested by the harvesting device. The harvesting header comprises a central portion, which is situated in front of the feeder house, and a left-hand portion and a right-hand portion which are each laterally offset in relation to the central portion. The harvesting header is configured to feed stalks that enter the central portion to the feeder house along with the grains.

In other words, in the left-hand and right-hand portions of the harvesting header, the harvesting device selectively harvests the grains of the crop. A stripper may be used for this purpose, or a cutter bar and a reel are operated in a high-cutting mode. In the central portion of the harvesting header, however, the harvesting device harvests not only the grains but also the stalks of the crop, which are fed, along with the grains entering from the left and the right, via a rear dispensing opening to the feeder house of a combine harvester. The stalks that remain standing on the field in the left-hand and right-hand portions are cut off by the additional cutting units arranged there and are deposited in a windrow or are chopped and spread.

The aforementioned disadvantages are thereby avoided. Firstly, a certain amount of straw that is picked up in the central portion is passed, along with the grains, through the feeder house and the combine harvester, thus reducing the aggressiveness of the threshing and separating device and thus the proportion of broken grains in the grain tank, and secondly, no additional cutting unit is required underneath the feeder house, thus increasing the design freedom and possibilities both with regard to the harvesting device and with regard to the additional cutting unit.

In one implementation there is provided a harvesting header for a combine harvester harvesting crops with grains growing in stalks and including a feeder house. The harvesting header includes a frame structure which is movable in a forward direction (V) over a field and to which there is attached a harvesting device, which extends over an entire width of the harvesting header and which serves for harvesting the grains of the crop and a rear dispensing opening wherein a crop flow is fed through the rear dispensing opening to the feeder house. The harvesting header further includes a central portion, which is situated in front of the feeder house, and a left-hand portion and a right-hand portion which are each laterally offset in relation to the central portion. The harvesting header also includes an additional cutting unit for processing the stalks that remain on the field after the grains have been harvested by the harvesting device, wherein the harvesting header is configured to feed stalks that enter the central portion to the feeder house along with the grains.

In some implementations the harvesting header includes wherein the additional cutting unit is assigned only to the left-hand and right-hand portions.

In some implementations the harvesting header includes a cutter being provided in the central portion for the purposes of cutting off the stalks that stand in the central portion.

In some implementations the harvesting header includes wherein the harvesting device includes in each case one stripper, or cutter bars operating in a high-cutting mode and reels, in the left-hand and right-hand portions.

In some implementations the harvesting header includes wherein the harvesting device includes a stripper, or a cutter bar operating in a high-cutting mode and a reel, in the central portion.

In some implementations the harvesting header includes wherein the harvesting device includes, in the left-hand and right-hand portions, in each case one transverse conveyor device that feeds the crop to a base arranged in the central region, onto which base stalks that are cut off by the cutter in the central portion also pass and from which base the crop can be fed through the dispensing opening to the feeder house.

In some implementations the harvesting header includes wherein the additional cutting unit includes a cutter for cutting off the stalks and including a conveyor rotor which can be operated in a windrowing operating mode in order to convey the cut-off stalks to a discharge hood or to a transverse conveyor belt for the purposes of depositing the stalks in a windrow.

In some implementations the harvesting header includes wherein the discharge hood is configured to be articulated at its front, upper end on the frame structure so as to be pivotable about a pivot axis extending horizontally and transversely with respect to the forward direction V, in order for the discharge hood to be moved into a non-operational position above the harvesting header, in which position the harvesting header can be dismounted from the feeder house and placed onto a cutting unit transport vehicle and towed behind the combine harvester for the purposes of being transported on a road.

In some implementations the harvesting header includes wherein the conveyor rotor, in a chopping operating mode, is movable into a deactivated raised position or driveable in a direction of rotation which is reversed in relation to the windrowing operating mode and in which the conveyor rotor feeds the stalks to a chopping rotor or comminutes the stalks in interaction with counterpart blades.

In another implementation there is provided a combine harvester for harvesting grains of crops. The combine harvester includes a feeder house and a harvesting header, removably attached to the feeder house. The harvesting header includes a harvesting device which extends over an entire width of the harvesting header and which serves for harvesting the grains of the crop. The harvesting header also includes a rear dispensing opening, wherein a crop flow is fed through the rear dispensing opening to the feeder house, a central portion, which is situated in front of the feeder house, and a left-hand portion and a right-hand portion which are each laterally offset in relation to the central portion. The harvesting header further includes an additional cutting unit for processing the stalks that remain on the field after the grains have been harvested by the harvesting device, wherein the harvesting header is configured to feed stalks that enter the central portion to the feeder house along with the grains.

In some implementations the combine harvester includes wherein the additional cutting unit is assigned only to the left-hand and right-hand portions.

In some implementations the combine harvester includes a cutter being provided in the central portion for the purposes of cutting off the stalks that stand in the central portion.

In some implementations the combine harvester includes wherein the harvesting device includes in each case one stripper, or cutter bars operating in a high-cutting mode and reels, in the left-hand and right-hand portions.

In some implementations the combine harvester includes wherein the harvesting device includes a stripper, or a cutter bar operating in a high-cutting mode and a reel, in the central portion.

In some implementations the combine harvester includes wherein the harvesting device includes, in the left-hand and right-hand portions, in each case one transverse conveyor device that feeds the crop to a base arranged in the central region, onto which base stalks that are cut off by the cutter in the central portion also pass and from which base the crop can be fed through the dispensing opening to the feeder house.

In some implementations the combine harvester includes wherein the additional cutting unit includes a cutter for cutting off the stalks and including a conveyor rotor which can be operated in a windrowing operating mode in order to convey the cut-off stalks to a discharge hood or to a transverse conveyor belt for the purposes of depositing the stalks in a windrow.

In some implementations the combine harvester includes wherein the discharge hood is configured to be articulated at its front, upper end on the frame structure so as to be pivotable about a pivot axis extending horizontally and transversely with respect to the forward direction V, in order for the discharge hood to be moved into a non-operational position above the harvesting header, in which position the harvesting header can be dismounted from the feeder house and placed onto a cutting unit transport vehicle and towed behind the combine harvester for the purposes of being transported on a road.

In some implementations the combine harvester includes wherein the conveyor rotor, in a chopping operating mode, is movable into a deactivated raised position or driveable in a direction of rotation which is reversed in relation to the windrowing operating mode and in which the conveyor rotor feeds the stalks to a chopping rotor or comminutes the stalks in interaction with counterpart blades.

In a further implementation there is provided method for harvesting a crop having grains growing on stalks with a harvesting header of a combine harvester. The method includes: moving the harvesting header in a forward direction over a field; harvesting the crop while moving the harvesting header in the forward direction; selectively harvesting the grains of the crop from the stalks in a left-hand and a right-hand portion of the harvesting header; and harvesting both the grains and the stalks of the crop in a central portion of the harvesting header.

In some implementations, the method includes feeding the grain and stalks of crop harvested with the central portion along with the grain harvested with the left hand and right hand portion of the harvesting header to a rear dispensing opening of the harvesting header to a feeder house of the combine harvester.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings.

The drawings illustrate four exemplary implementations of the disclosure, which are described in more detail below. In the drawings:

FIG. 1 shows a schematic side view of a combine harvester having a harvesting header for harvesting the upper parts of the plants, which harvesting header is equipped with an additional cutting unit for the stalks;

FIG. 2 shows a perspective view of the harvesting header from FIG. 1 from the front and above,

FIG. 3 shows a perspective view of the harvesting header from FIG. 1 from the rear and below,

FIG. 4 shows a vertical section through the harvesting header along the line 4-4 in FIG. 2,

FIG. 5 shows a vertical section through the harvesting header along the line 5-5 in FIG. 2 during chopping operation;

FIG. 6 shows a section corresponding to FIG. 4 or 5 with a windrow-forming plate having been pivoted up for the purposes of on-road transport;

FIG. 7 shows a section corresponding to FIG. 4 or 5 through a second implementation of the additional cutting unit;

FIG. 8 shows a section corresponding to FIG. 4 or 5 through a third implementation of the additional cutting unit; and

FIG. 9 shows a perspective view of a further implementation of the harvesting header.

### DETAILED DESCRIPTION

For the purposes of promoting an understanding of the principles of the novel disclosure, reference will now be made to the implementations described herein and illustrated in the drawings and specific language will be used to describe the same. It will nevertheless be understood that no limitation of the scope of the novel disclosure is thereby intended, such alterations and further modifications in the illustrated devices and methods, and such further applications of the principles of the novel disclosure as illustrated therein being contemplated as would normally occur to one skilled in the art to which the novel disclosure relates.

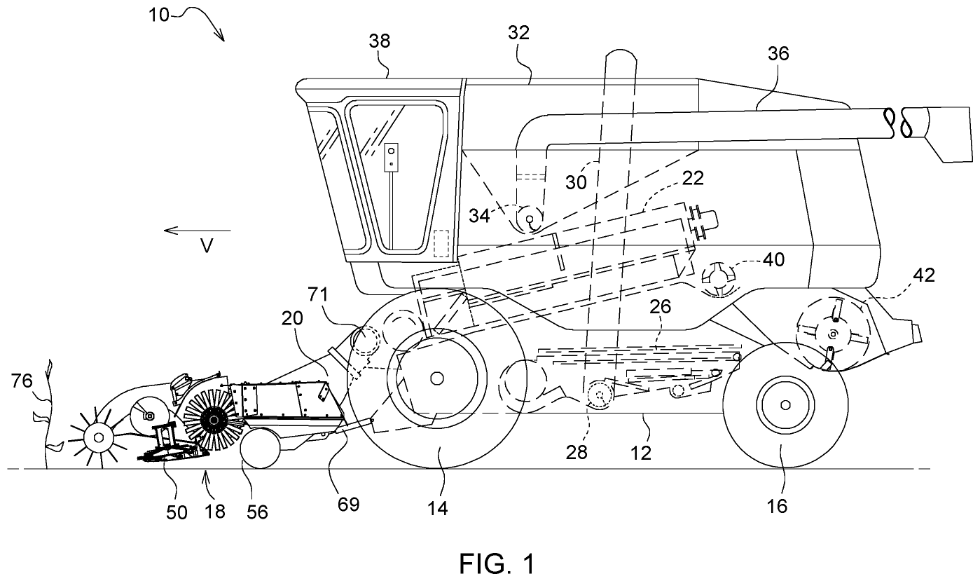

FIG. 1 shows a self-propelled harvesting machine in the form of a combine harvester 10, having a chassis 12 which is supported on the ground via driven front wheels 14 and steerable rear wheels 16 and which is moved by said wheels. The wheels 14, 16 are set in rotation by drive means (not shown) in order to move the combine harvester 10, for example, over a field that is to be harvested. In the following text, direction indications, such as front and rear, relate to the direction of travel V, running to the left in FIG. 1, of the combine harvester 10 in harvesting operation.

At the front end region of the combine harvester 10, a harvesting header 18 is removably attached to a feeder house 20 in order, during harvesting operation, to harvest the cars or grains of crops 76 in the form of cereals or other threshable straw crops from the field and feed these upward and rearward through the feeder house 20 (which is pivotable about the axis of rotation of an upper diverting roller 71 of the feeder house 20, and thus height-adjustable, by means of a cylinder 69) to an axial threshing unit 22. The mixture passing through threshing concaves and gratings in the axial threshing unit 22 and containing grains and contaminants passes into a cleaning device 26. Cereal cleaned by the cleaning device 26 is fed by means of a grain screw 28 to a grain elevator 30, which conveys said cereal into a grain tank 32. The cleaned cereal from the grain tank 32 can be discharged through a discharge system having a transverse screw 34 and having a discharge conveyor designed as a screw conveyor assembly 36. The crop residues output by the axial threshing unit 22 are fed by means of a conveyor drum 40 to a straw chopper 42, which comminutes said crop residues and spreads them over the field over the width of the cutting unit 18. The abovementioned systems are driven by means of a combustion engine and are monitored and controlled by an operator from a driver's cab 38. The illustrated axial threshing unit 22 having one or more axial threshing and separating rotors is just one exemplary implementation, and could be substituted for example by a tangential threshing unit of one or more threshing drums and downstream straw walkers or separating rotor(s).

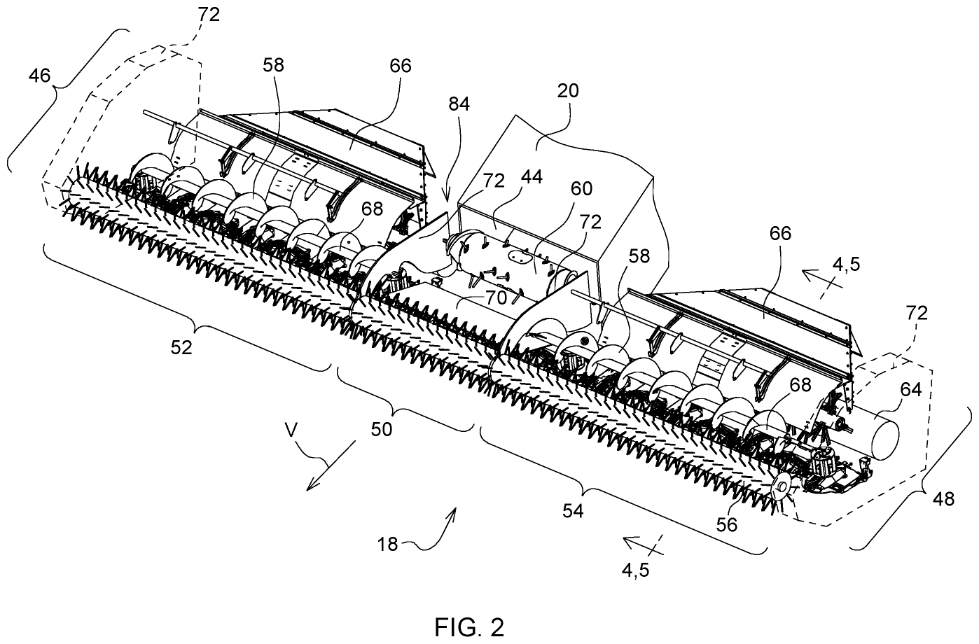

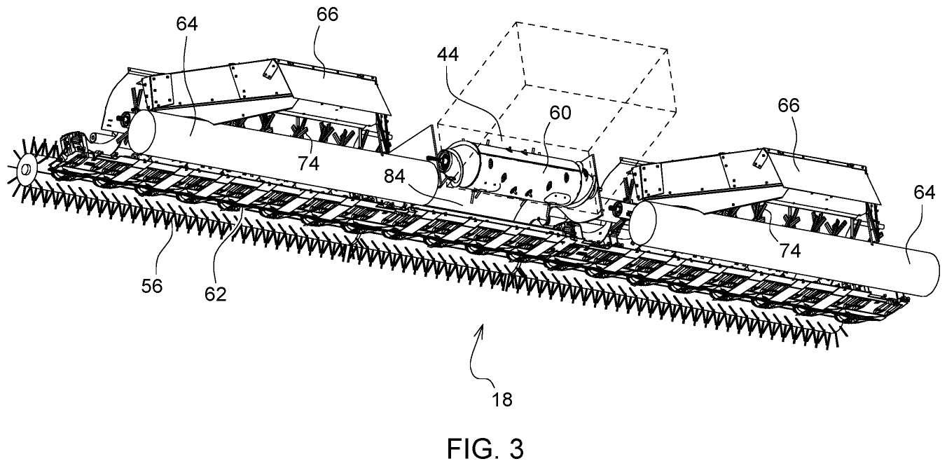

The harvesting header 18 is shown in FIGS. 2 and 3 in a perspective view from front left and above, and from rear left and below, respectively. The harvesting header 18 comprises a frame structure 44, to which a first region which serves as a harvesting device 46 for harvesting the grains of the crop 76 is attached at the front and top side, whilst a second, rear and bottom region is provided as an additional cutting unit 48 for processing the stalks. The harvesting header 18 is divided in a lateral direction into a central portion 50 and a right-hand portion 52 and a left-hand portion 54 in relation to the forward direction V. To the rear of the central portion 50, the harvesting header 18 is removably attached to the feeder house 20. The width of the central portion 50 at least approximately corresponds to the width of the feeder house 20.

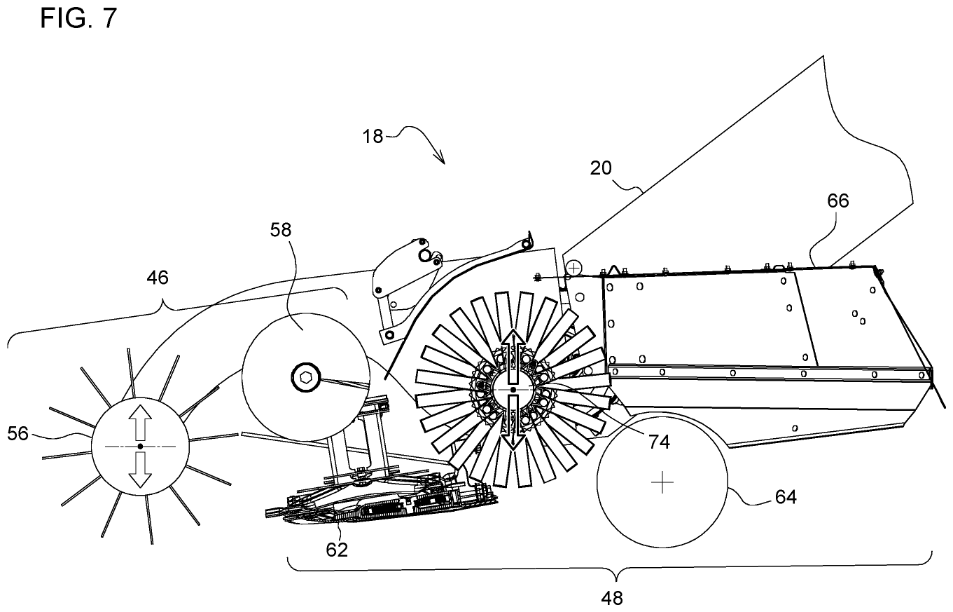

The harvesting device 46 of the harvesting header 18 comprises a so-called stripper 56 which, in the implementation illustrated in FIGS. 2 to 8, extends over the entire width of the harvesting header 18. In a manner known per se (see EP 0 241 276 A1 or EP 0 432 318 A1), the stripper 56 separates the cars from the crop 76 by pulling them from the stalks by means of a rotor, which is set in rotation, and stripping means attached to said rotor. In the left-hand and right-hand portions 52, 54 (but not in the central portion 50), transverse conveyor devices 58 are arranged to the rear of the stripper 56 and transport the stripped-off cars to the central portion 50. In FIGS. 2 to 8, the transverse conveyor devices 58 are designed as transverse conveyor screws with troughs 68 arranged under them, although in another implementation they could also be implemented as conveyor belts. In the central portion 50, the transverse conveyor devices 68 discharge the cars onto a lower base 70, onto which the cars that are separated from the crop 76 by the stripper 56 in the central portion 50 also fall. A rear, upper conveyor 60 conveys the cars in an undershot movement from the base 70 of the central portion 50 through a rear dispensing opening 84 of the harvesting header 18 into the feeder house 20. The transverse conveyor devices 68 and the stripper 56 are supported on the frame structure 44 by holding arms 72, which are pivotable about the transverse axis relative to the frame structure 44, and/or are adjustable in length along the longitudinal axis of the holding arms 72, by means of actuators (not shown). In this way, the position of the stripper 56 and of the transverse conveyor devices 68 can be adapted in a horizontal and/or vertical direction to the height of the crop 68, as indicated in FIG. 7, and can for example be lowered in order to take in lodged cereal crops, either by the operator of the combine harvester 10 or automatically, analogously to an adjustment, known per se, of a reel and of a cutter bar of a cutting unit, cf. EP 3 430 881 A1.

The base 70 may be fastened passively, that is to say rigidly and immovably, to the frame structure 44, as shown in the figures, or may be designed as a driven conveyor belt or any other type of conveyor that conveys the crop rearward in an overshot movement to the rear dispensing opening 84.

As shown in FIGS. 2 and 3, the additional cutting unit 48 comprises a cutter 62 (the central part of which functionally belongs to the harvesting device 46) which extends over the entire width of the harvesting header 18, conveyor rotors 74 which are arranged in each case only in the left-hand and right-hand portions 52, 54 of the harvesting header 18 and which extend transversely with respect to the forward direction V, chopping rotors 64 which extend transversely with respect to the forward direction V, and discharge hoods 66 arranged at the rear. As stated above, by means of the additional cutting unit 48, the stalks that remain in the ground after the ears have been stripped from the crop 76 are cut from the ground by means of the cutter 62 and are either deposited in one or more windrows on the field or are chopped and deposited on the field in a manner spread over the width of the harvesting header 18.

The conveyor rotors 74, chopping rotors 64 and discharge hoods 66 are arranged only in the left-hand and right-hand portions 52, 54 of the harvesting header 18, not in the central portion 50. The stalks of the crop that stand in the central portion 50 are thus cut off by the central region of the cutter 62 (which is functionally part of the harvesting device 46) that is arranged there, and said stalks pass directly onto the base 70, onto which the ears of the crop 76 that enter over the entire width of the harvesting header 18 are also transferred. The stalks that enter in the central portion 50 thus pass through the feeder house 20 and the combine harvester 10, and at the rear end thereof, in a windrowing mode, are led past the straw chopper 42 and are deposited as a windrow on the field, or in a chopping mode, are led through the straw chopper 42 and are spread in the form of chopped material (preferably only) over the width of the central portion 50 of the harvesting header 18 by means of spreading devices (not shown in FIG. 1) situated downstream of said straw chopper, which spreading devices may also be omitted or moved into an inactive position, in particular if the width of the straw chopper 42 approximately corresponds to the width of the central portion 50.

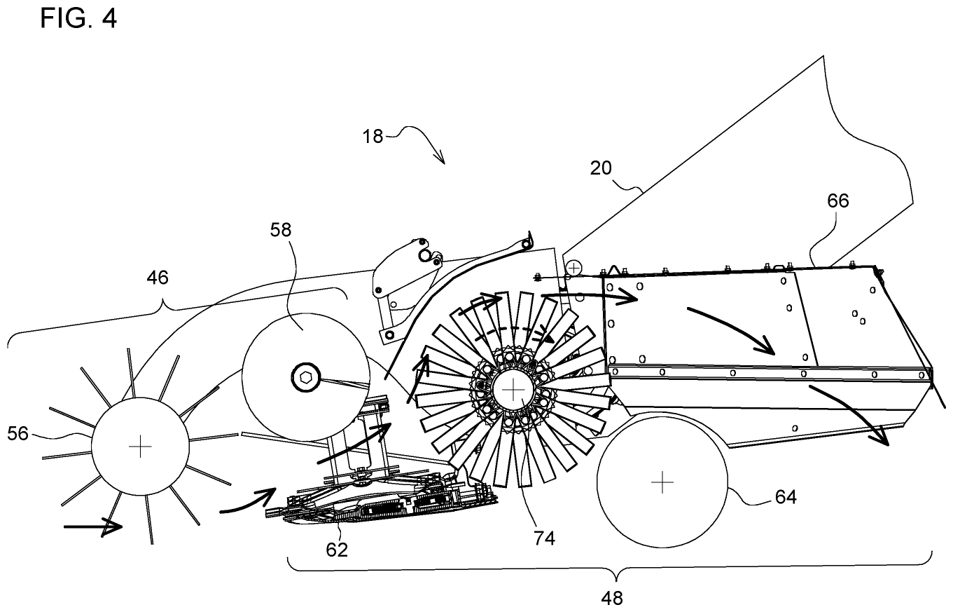

FIG. 4 shows the additional cutting unit 48 in a windrowing mode. The cutter 62, which is designed as a disk-type cutter 62, cuts the stalks of the crop 76 from the ground. The stalks that are cut off in the left-hand and right-hand portions 52, 54 are picked up by the conveyor rotor 74 arranged there and are conveyed in an overshot movement and flung against the discharge hood 66, which brings the chopped material together laterally and deposits it in a windrow. These windrows may be deposited on the field centrally in each case in the left-hand and right-hand portions 52, 54, or are guided to the center of the harvesting header 18 and are deposited there underneath the feeder house 20. Both cases avoid a situation in which the wheels 14, 16 of the combine harvester 10 travel over the windrow. If three windrows are deposited behind the working width of the harvesting header, these may be collected successively, or they are picked up in a single working operation by a baler or a forage harvester with a sufficiently wide pickup, or they are firstly merged to form a single windrow.

In a further implementation that is not shown, the discharge hoods 66 may be replaced by transverse conveyor belts which convey the stalks in a transverse direction and deposit them at one of the locations mentioned in the previous paragraph.

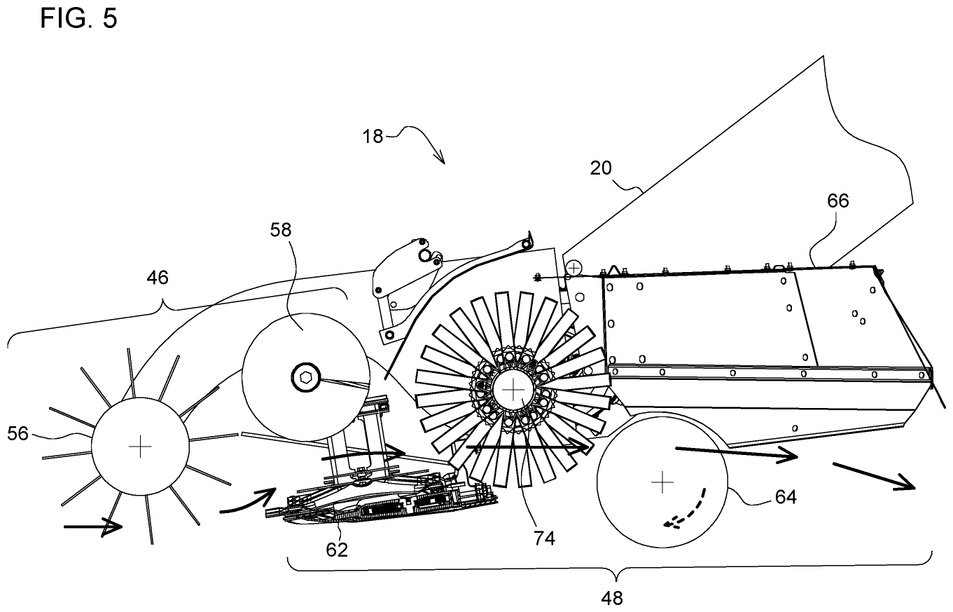

FIG. 5 shows the additional cutting unit 48 in a chopping mode. The cutter 62, which may also be designed in the form of cutter bars such as are conventional in cutting units, cuts the stalks of the crop 76 from the ground. The stalks that are cut off in the left-hand and right-hand portions 52, 54 are picked up by the conveyor rotor 74 arranged there and are conveyed in an undershot movement and fed to the chopping rotor 64, which comminutes said stalks and deposits them on the field in a manner spread over the width of the left-hand and right-hand portions 52, 54. The chopping rotors 64 may be designed, in a manner known per se, as flail choppers, cf. DE 10 2011 051 981 A1.

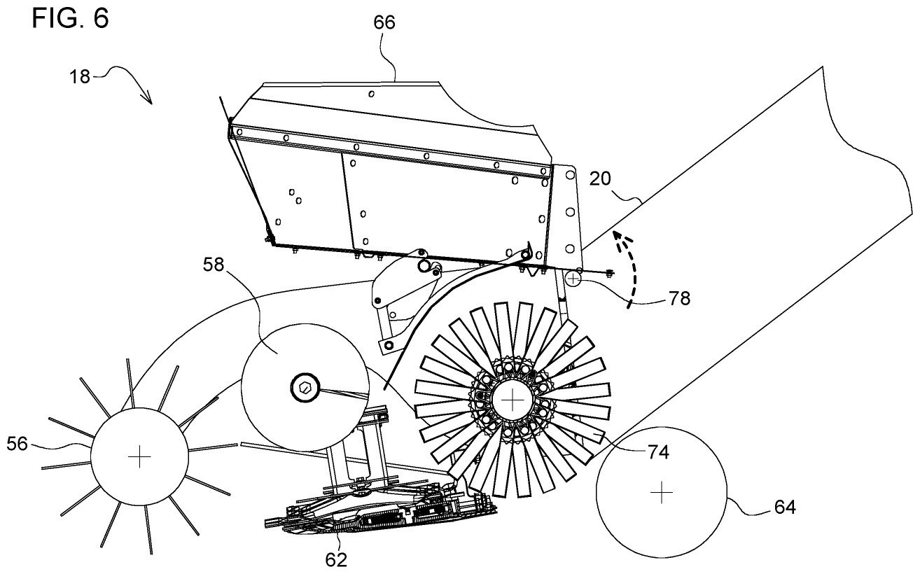

As shown in FIG. 6, the discharge hoods 66 may be articulated at their front, upper ends on the frame structure 44 so as to be pivotable about a pivot axis 78 extending horizontally and transversely with respect to the forward direction V, in order that said discharge hoods can be moved into the non-operational position above the harvesting header 18 as shown in FIG. 7, in which position the harvesting header 18 can be dismounted from the feeder house 20 and placed onto a cutting unit transport vehicle and towed behind the combine harvester 10 for the purposes of being transported on a road. The discharge hoods 66 may be pivoted manually by an operator, or by means of an actuator (not shown).

FIG. 7 illustrates an implementation in which the conveyor rotors 74 have, for chopping operation, been moved into a raised position in which their drive can be deactivated. For windrowing operation, the conveyor rotors 74 are lowered, and their drive is activated. The adjustment between the operational and non-operational positions may be performed manually by the operator, or by means of an actuator.

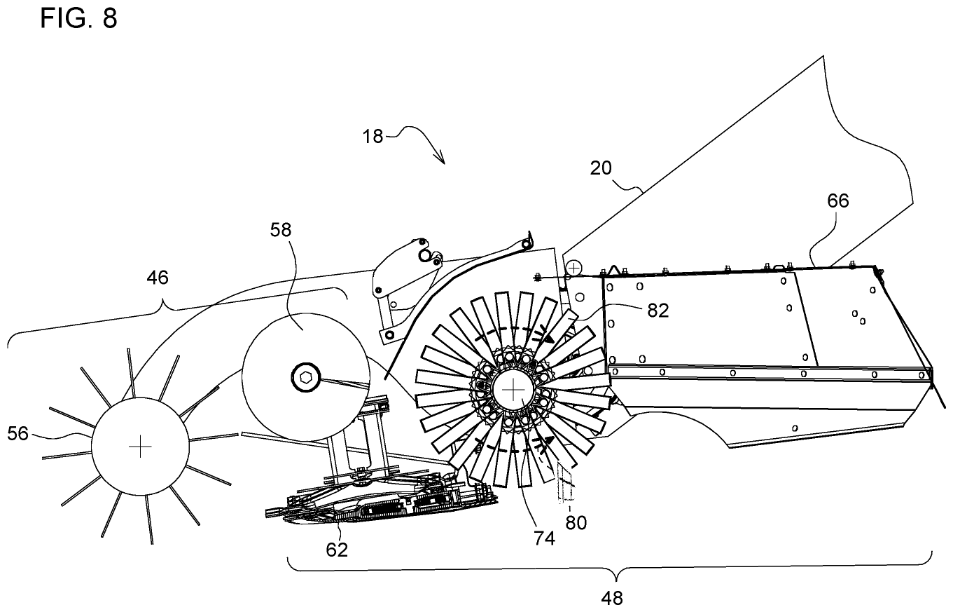

In the implementation in FIG. 8, the chopping rotors 64 been omitted, and their function is performed by the conveyor rotors 74 which, during chopping operation, analogously to FIG. 5, operate in an undershot configuration and interact with counterpart blades 80 which protrude in each case between the rows of drivers 82 that are distributed over the conveyor rotors 74 in an axial and circumferential direction. Here, the leading flanks of the drivers 82 during chopping operation, and/or the front surfaces, interacting with said flanks, of the counterpart blades 80, may be sharpened.

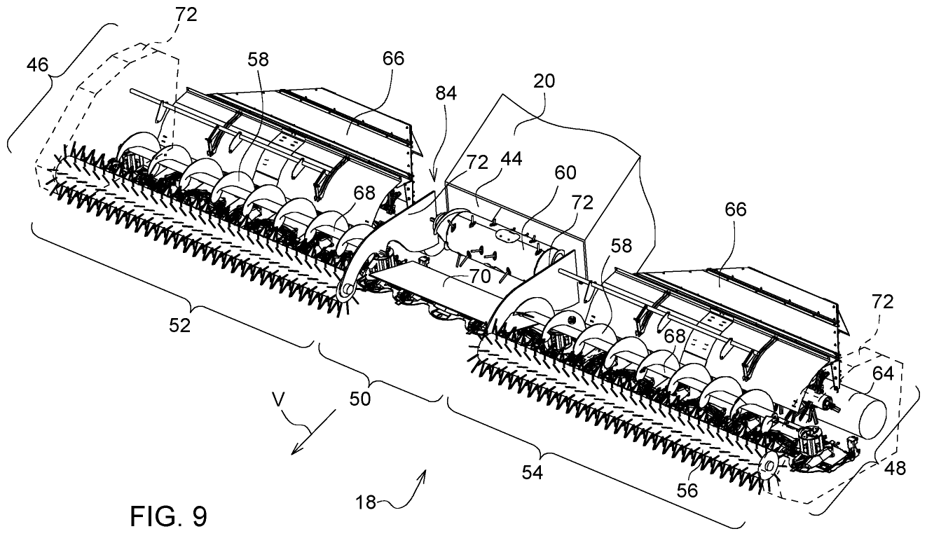

Since crops 76 entering the central portion 50 are cut off by that part of the cutter 62 which is arranged there, it is in principle not necessary for a stripper 56 to be provided in the central portion 50 of the harvesting header 18. In the implementation of FIG. 9, the stripper 56 has thus been omitted in the central portion 50.

It is also to be noted that the drive of the stripper 56, of the transverse conveyor devices 68, of the cutter 62 and of the conveyor rotors 74 and chopping rotors 64 may be derived from the feeder house 20 via mechanical drivetrains, in a manner known per se. When, for example, the chopping rotors 64 are not in use in the windrowing mode of FIG. 4, or when the conveyor rotors 74 have been moved into an inactive raised position in the chopping mode as per FIG. 7, the relevant drivetrain may be disconnected by means of a clutch. Alternatively, one or more of said elements (stripper 56, transverse conveyor devices 68, cutter 62, conveyor rotors 74, chopping rotors 64) may be assigned an electrically or hydraulically operated motor.

Furthermore, the strippers 56 could be substituted by conventional cutter bars, operating in a high-cutting mode, and reels (see for example DE 10 2005 025 319 A1). Analogously to FIGS. 2 and 9, the cutter bar and the reels may be present (as in FIG. 2) or omitted (as in FIG. 9) in the central portion.

The fact that the stalks of the crop 76 entering the central portion 50 are also taken into the feeder house 20 and thus into the combine harvester 10 consequently clearly has numerous advantages. This prevents the threshing and separating devices of the axial threshing unit 22 (or of a tangential threshing unit with downstream separating rotors or straw walkers) from exerting too aggressive an action on the grains of the crop, because it is ensured that a certain proportion of stalks (straw) is conveyed with said grains, which can make the action of the threshing and separating device less aggressive to a certain extent. The need to provide the additional cutting unit 48 underneath the feeder house 20 is also eliminated, which improves the design possibilities for the additional cutting unit 48, and the feeder house 20 can also be lowered to a relatively great extent, thus allowing a stripper 56 to be used to pick up even lodged cereal crops.

While the above describes example implementations of the present disclosure, these descriptions should not be viewed in a limiting sense. Rather, other variations and modifications may be made without departing from the scope and spirit of the present disclosure as defined in the appended claims

1. A harvesting header for a combine harvester harvesting crops with grains growing in stalks and including a feeder house, the harvesting header comprising:
a frame structure which is movable in a forward direction (V) over a field and to which there is attached a harvesting device, which extends over an entire width of the harvesting header and which serves for harvesting the grains of the crop;
a rear dispensing opening, wherein a crop flow is fed through the rear dispensing opening to the feeder house;
a central portion, which is situated in front of the feeder house, and a left-hand portion and a right-hand portion which are each laterally offset in relation to the central portion,
an additional cutting unit for processing the stalks that remain on the field after the grains have been harvested by the harvesting device; and
wherein the harvesting header is configured to feed stalks that enter the central portion to the feeder house along with the grains.

2. The harvesting header as claimed in claim 1, wherein the additional cutting unit is assigned only to the left-hand and right-hand portions.

3. The harvesting header as claimed in claim 1, including a cutter being provided in the central portion for the purposes of cutting off the stalks that stand in the central portion.

4. The harvesting header as claimed in claim 1, wherein the harvesting device includes in each case one stripper, or cutter bars operating in a high-cutting mode and reels, in the left-hand and right-hand portions.

5. The harvesting header as claimed in claim 4, the harvesting device includes a stripper, or a cutter bar operating in a high-cutting mode and a reel, in the central portion.

6. The harvesting header as claimed in claim 3, wherein the harvesting device includes, in the left-hand and right-hand portions, in each case one transverse conveyor device that feeds the crop to a base arranged in the central region, onto which base stalks that are cut off by the cutter in the central portion also pass and from which base the crop can be fed through the dispensing opening to the feeder house.

7. The harvesting header as claimed in claim 1, wherein the additional cutting unit includes a cutter for cutting off the stalks and including a conveyor rotor which can be operated in a windrowing operating mode in order to convey the cut-off stalks to a discharge hood or to a transverse conveyor belt for the purposes of depositing the stalks in a windrow.

8. The harvesting header as claimed in claim 7, wherein the discharge hood is configured to be articulated at its front, upper end on the frame structure so as to be pivotable about a pivot axis extending horizontally and transversely with respect to the forward direction V, in order for the discharge hood to be moved into a non-operational position above the harvesting header, in which position the harvesting header can be dismounted from the feeder house and placed onto a cutting unit transport vehicle and towed behind the combine harvester for the purposes of being transported on a road.

9. The harvesting header as claimed in claim 7, wherein the conveyor rotor, in a chopping operating mode, is movable into a deactivated raised position or driveable in a direction of rotation which is reversed in relation to the windrowing operating mode and in which the conveyor rotor feeds the stalks to a chopping rotor or comminutes the stalks in interaction with counterpart blades.

10. A combine harvester for harvesting grains of crops, the combine harvester comprising:
a feeder house;
a harvesting header, removably attached to the feeder house, the harvesting header including a harvesting device which extends over an entire width of the harvesting header and which serves for harvesting the grains of the crop, wherein the harvesting header includes:
a rear dispensing opening, wherein a crop flow is fed through the rear dispensing opening to the feeder house;
a central portion, which is situated in front of the feeder house, and a left-hand portion and a right-hand portion which are each laterally offset in relation to the central portion,
an additional cutting unit for processing the stalks that remain on the field after the grains have been harvested by the harvesting device;
wherein the harvesting header is configured to feed stalks that enter the central portion to the feeder house along with the grains.

11. The combine harvester as claimed in claim 10, wherein the additional cutting unit is assigned only to the left-hand and right-hand portions.

12. The combine harvester as claimed in claim 10, including a cutter being provided in the central portion for the purposes of cutting off the stalks that stand in the central portion.

13. The combine harvester as claimed in claim 10, wherein the harvesting device includes in each case one stripper, or cutter bars operating in a high-cutting mode and reels, in the left-hand and right-hand portions.

14. The combine harvester as claimed in claim 13, wherein the harvesting device includes a stripper, or a cutter bar operating in a high-cutting mode and a reel, in the central portion.

15. The combine harvester as claimed in claim 12, wherein the harvesting device includes, in the left-hand and right-hand portions, in each case one transverse conveyor device that feeds the crop to a base arranged in the central region, onto which base stalks that are cut off by the cutter in the central portion also pass and from which base the crop can be fed through the dispensing opening to the feeder house.

16. The combine harvester as claimed in claim 10, wherein the additional cutting unit includes a cutter for cutting off the stalks and including a conveyor rotor which can be operated in a windrowing operating mode in order to convey the cut-off stalks to a discharge hood or to a transverse conveyor belt for the purposes of depositing the stalks in a windrow.

17. The combine harvester as claimed in claim 16, wherein the discharge hood is configured to be articulated at its front, upper end on the frame structure so as to be pivotable about a pivot axis extending horizontally and transversely with respect to the forward direction V, in order for the discharge hood to be moved into a non-operational position above the harvesting header, in which position the harvesting header can be dismounted from the feeder house and placed onto a cutting unit transport vehicle and towed behind the combine harvester for the purposes of being transported on a road.

18. The combine harvester as claimed in claim 16, wherein the conveyor rotor, in a chopping operating mode, is movable into a deactivated raised position or driveable in a direction of rotation which is reversed in relation to the windrowing operating mode and in which the conveyor rotor feeds the stalks to a chopping rotor or comminutes the stalks in interaction with counterpart blades.

19. A method for harvesting a crop having grains growing on stalks with a harvesting header of a combine harvester, the method comprising:
moving the harvesting header in a forward direction over a field;
harvesting the crop while moving the harvesting header in the forward direction;
selectively harvesting the grains of the crop from the stalks in a left-hand and a right-hand portion of the harvesting header; and
harvesting both the grains and the stalks of the crop in a central portion of the harvesting header.

20. The method of claim 19 further comprising feeding the grain and stalks of crop harvested with the central portion along with the grain harvested with the left hand and right hand portion of the harvesting header to a rear dispensing opening of the harvesting header to a feeder house of the combine harvester.
